(19) United States
(12) Patent Application Publication
(10) Pub. No.: US 2025/0109733 A1
(43) Pub. Date: Apr. 3, 2025

(54) WIND TURBINE WITH WIND RESPONSIVE FAIRING

(71) Applicant: Benton Frederick Baugh, Houston, TX (US)

(72) Inventor: Benton Frederick Baugh, Houston, TX (US)

(21) Appl. No.: 18/375,041

(22) Filed: Sep. 29, 2023

(51) Int. Cl. F03D 7/02; F03D 1/06

(52) U.S. Cl. CPC F03D 7/0224; F03D 1/06

(57) ABSTRACT

The method of fairing the blades of a wind turbine in which the angle of the blades is sensitive to the wind speed, providing blades which are pivotably mounted on a blade mounting about a blade axis generally perpendicular to the axis of wind turbine rotation, providing the blades have more wind surface area facing the wind on one side of the blade axis than the other side of the blade axis giving a torsion on the blades about the blade axis due to wind load, providing a moment arm mounted on each of the blades which translates the torsion into force proximately parallel to the axis of wind turbine rotation, providing a reaction plate to receive the force generated by the torsion, supporting the reaction plate by springs such that increasing wind load will move the reaction plate and change the angle of the blades.

### TECHNICAL FIELD

This invention relates to the method of using the force of the wind against the blades to fair the blades to a preferred angle.

### BACKGROUND OF THE INVENTION

Wind turbines have the potential to be and should be a sustaining economic supply of green energy for the United States and the world.

Wind turbines were optimized in the nineteenth century by theories and a lot of empirical evidence, yielding a common design which farmers have used for pumping water ever since. The designs generally favored several blades with a lot of blade surface area.

For a variety of reasons, more recent wind turbines have favored few blades, typically three, with a minimal surface area and a highly profiled shape.

The following is a direct quotation taken from the internet “The best overall formula for the power derived from a wind turbine (in Watts) is P=0.5 CpρπR² V³ where Cp is the coefficient of performance (efficiency factor, in percent), p is air density (in kg/m3). R is the blade length (in meters) and V is the wind speed (in meters per second).” Note: πR² is the area the blades sweep or the swept area, (Number 1 result in an internet search for wind power formula.)

Also, “The wind energy formula is given by P=0.5*ρ*A*V\hat{ }3. where, P=power, ρ=air density, A=swept area of blades given by A=π*R² where R is the radius of the blades. V=velocity of the wind.” (From BYJU'S Learning Program)

These (and many other similar references) indicate that wind power is a function of the area the blades sweep rather than the blade area itself. It is sort of like saying an airplane flew from Houston to Oklahoma City and the lift of the wings was a function of the flight path from Houston to Oklahoma City rather than the area of the wings.

It is our understanding based on our experience of substantial testing of our own that wind energy is not a function of the area the blades sweep as conventionally understood, but rather of actual blade area as the nineteenth century farmers figured out.

It is reasonable to say that today wind turbines are not economically viable as they are only installed where there are government grants to at least partially pay for them, if not completely.

Optimizing wind turbines on the basis of blade area rather than swept area substantially changes how you would design blades. It generally changes you to getting as much area you can in a small diameter rather than having inordinately long blades to optimize swept area. It is our testing experience that in doing this, you can generate at least ten times as much wind energy in the same swept area as the contemporary designs.

By changing the design of wind turbines to optimize based on blade area will represent new methodologies of design and construction. Some of these will be radically different blade designs, substantially different tower designs as blades will be shorter and will not require tall towers for support, new needs for blade angle control and centrifugal releases as large blade areas will tend to over speed in high winds,

The more compact blades will allow portable wind turbines which can power small communities. Different philosophies will be addressed in wind turbines which can be used in direct current service where blade rotational speed is a secondary consideration and in service where you feed to an alternating current grid and the cycle timing is critical.

The present design philosophies have yielded wind turbines which are so enormous that it takes massive trucks to carry the components down the roads to erect them and enormous cranes to erect them. In a small scale which might be erected without these cranes, the power out would be so low as to not make them worth investigating.

We have been designing wind turbines by the swept area optimization method for at least 70 years. It is time to address optimizing wind turbines on blade area and make the wind power industry a tax paying industry rather than a tax consuming industry.

### BRIEF SUMMARY OF THE INVENTION

The object of this invention is to provide a method of collecting wind energy with a wind turbine based on optimizing the blade area rather than be blade swept area.

A second object of this invention is for the wind turbine blades to be faired to a preferred angle depending on the wind load from the approaching wind.

A third objective of this invention is to provide blades with a greater area on one side of a pivoting axle to provide a turning moment about that axle.

Another objective of this invention is translate the turning moment into a force approximately parallel to the axis of rotation of the wind turbine.

Another objective of this invention is to load the force parallel to the axis of rotation of the wind turbine against one or more springs.

Another objective of this invention is to provide a centrifugally actuated release if the blades rotate too fast.

Another objective of this invention is to use an actuator to reset the centrifugal release.

### BRIEF DESCRIPTION OF THE DRAWINGS

FIG. 1 is a perspective view of a wind turbine system which would use the features of this invention, and illustrates the blades at about a 30 degree angle to the plane of rotation.

FIG. 2 is a perspective view of a wind turbine system which would use the features of this invention, and illustrates the blades at about a 10 degree angle to the plane of rotation.

FIG. 3 is a perspective view of a wind turbine system which would use the features of this invention, and illustrates the blades at about a 90 degree angle to the plane of rotation.

FIG. 4 is an end view of a wind turbine system taken along lines “4-4” of FIG. 2 which would use the features of this invention showing the internal equipment which would be used.

FIG. 5 is a perspective view of a wind turbine system which would use the features of this invention illustrating the mast being erected without a crane.

FIG. 6 is a perspective view of a wind turbine system similar to FIG. 5 showing the wind turbine being attached to the top of the mast near ground level.

FIG. 7 is a perspective view of a wind turbine system similar to FIG. 6 rotated slightly and showing the wind turbine raised to the vertical mode of the mast.

FIG. 8 is a perspective view taken along lines “8-8” of FIG. 7 showing an overview of a fairing box which is sensitive to the wind load.

FIG. 9 is a perspective view taken from box 136 of FIG. 8 which shows blades in about a ten-degree position relative to the plane of rotation.

FIG. 10 is a perspective view taken from box 136 of FIG. 8 which shows blades in about a forty-five-degree position relative to the plane of rotation.

FIG. 11 is a perspective view taken from box 136 of FIG. 8 which shows blades in about a ninety-degree position relative to the plane of rotation as it would be after the centrifugal release has been released.

FIG. 12 is a perspective view similar to FIG. 8 slightly rotated showing the components of a linear actuator actuated fairing system.

FIG. 13 is an enlarged perspective view of a position sensor taken along lines “13-13” of FIG. 12 showing the rheostat.

FIG. 14 is an enlarged perspective view of a position sensor taken along lines “14-14” of FIG. 13 showing the spur gear on the rheostat engaging the rack on the slide arm.

FIG. 15 a perspective view similar to FIG. 12 slightly rotated showing the components of a generator drive system.

FIG. 16 a perspective view similar to FIG. 15 illustrating the components of the centrifugal release system.

FIG. 17 is a view of the centrifugal release taken along lines “17-17” of FIG. 16.

FIG. 18 is a view of the centrifugal release system taken along lines “18-18” of FIG. 17.

FIG. 19 is a cross section view of the centrifugal release taken along lines “19-19” of FIG. 17 showing the centrifugal release in the non-released condition.

FIG. 20 is a cross section view of the centrifugal release taken along lines “19-19” of FIG. 17 showing the centrifugal release in the partially released condition.

FIG. 21 is a cross section view of the centrifugal release taken along lines “18-18” of FIG. 17 showing the centrifugal release in the fully released condition.

### DETAILED DESCRIPTION OF THE INVENTION

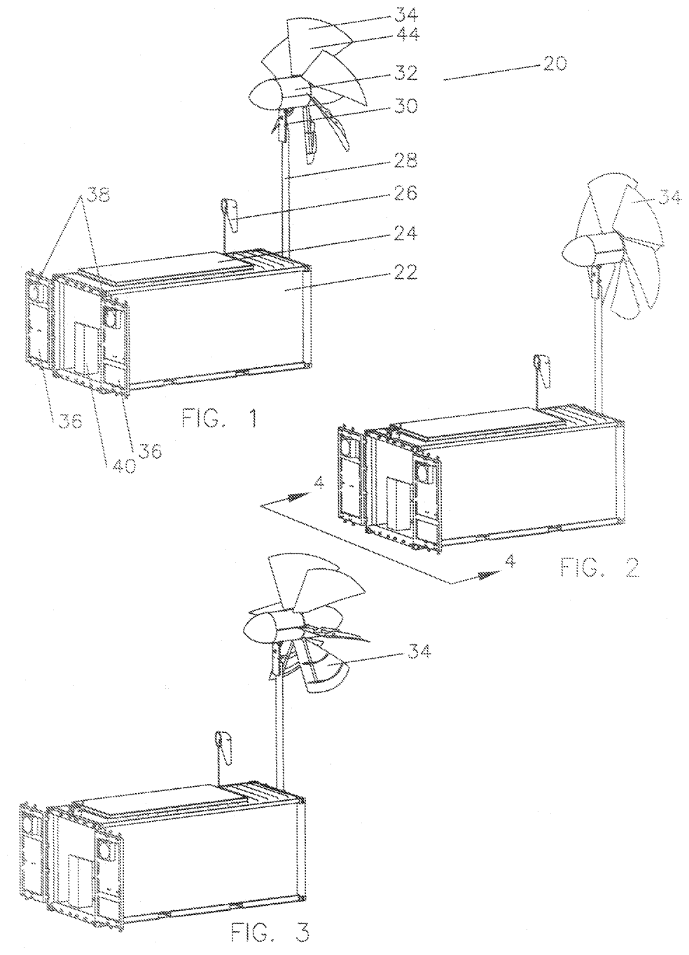

Referring now to FIG. 1, a perspective view of a complete wind turbine system 20 is shown in order to illustrate the utility of the present invention. Container 22 can be a custom-made structure or a standard shipping container. Solar cells 24 can be mounted on the top of container 22 to provide solar power in addition to wind power. Windsock 28 is shown to indicate wind direction. Mast 28 includes swivel bearings 30 which pivotably support the wind turbine pod 32 which in turn supports the blades 34. The blades 34 are shown at about a 30° angle to the wind direction as generally the best angle for harvesting the most power. The blades 34 are full area blades to gain the maximum power, as the three skinny blades typically in the field catch very little wind to harvest wind power. The doors 38 to the container are shown open with speakers 38 mounted on them. A lectern 40 is shown to allow a lecturer to speak to a crowd using the speakers 38. The side 44 of the blades 34 which face the wind are behind the swivel bearings 30 so that the wind turbine will always face into the wind.

Referring now to FIG. 2, a similar perspective view as FIG. 1 is shown with the blades 34 faired or turned to a moderate angle such as 10° which will be more beneficial in low wind conditions.

Referring now to FIG. 3, a similar perspective view as FIG. 1 is shown with the blades 34 faired or turned to an extreme angle such as 90° which will allow the blades to withstand hurricane conditions. The blades 34 can be faired to any angle between 10° and 90° to optimize the power drawn from the wind.

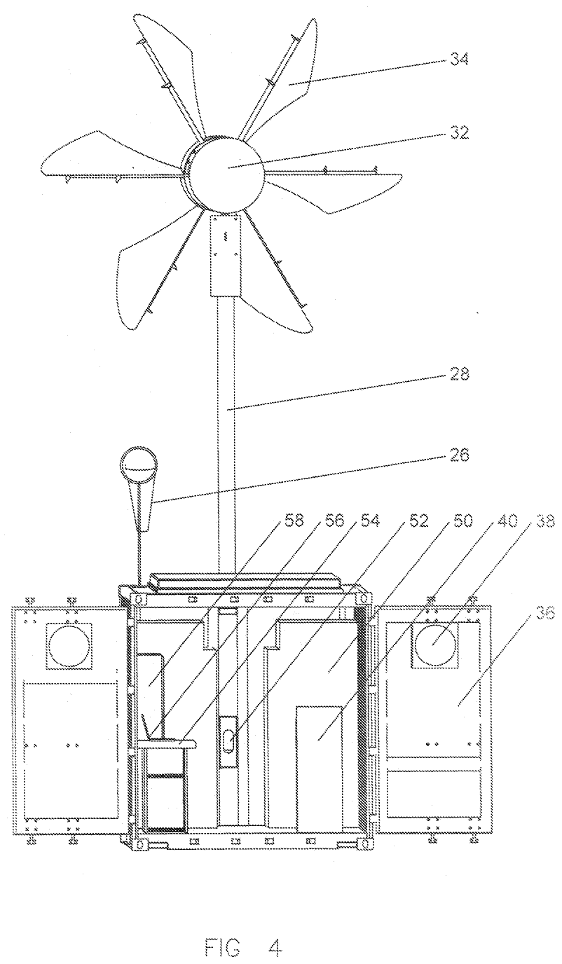

Referring now to FIG. 4, which is taken along lines “4-4” of FIG. 2 and shows storage batteries 50, lower end 52 of mast 28, office desk 54, computer 56, and power distribution panel 58.

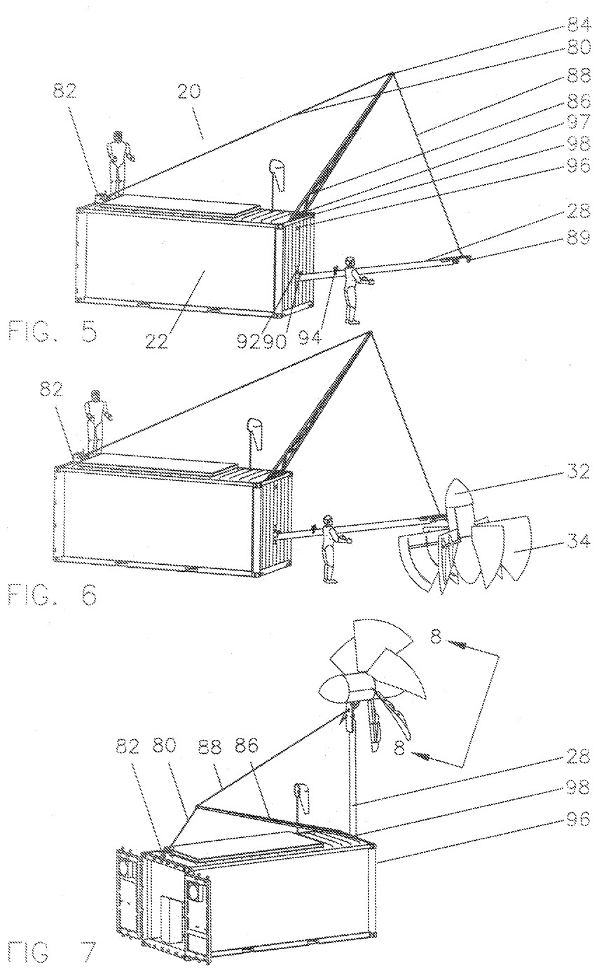

Referring now to FIG. 5, a perspective view of the wind turbine system 20 is shown with a first cable, wire, rope, or chain 80 attached to a winch 82 on one end and to the upper end 84 of a lightweight truss 86 on the other end. It also shows a second cable, wire, rope, or chain 88 attached to the upper end 84 of lightweight truss 88 on one end and to the upper end 89 of mast 28 on the other end. The lower end 90 of mast 28 is shown engaged with pivotable mount 92. Upper mount 94 will engage mounting location 96 when the mast is raised.

After the mast 28 is connected to the container 22 and the cables, wires, ropes, or chains 80 and 88 are attached to the top of the lightweight truss 86, the lower end 97 of the lightweight truss 86 is connected to a pivotable foot 98 on the top of the container 22. Winch 82 can then be used to raise the mast 28 to the position as shown in FIG. 5.

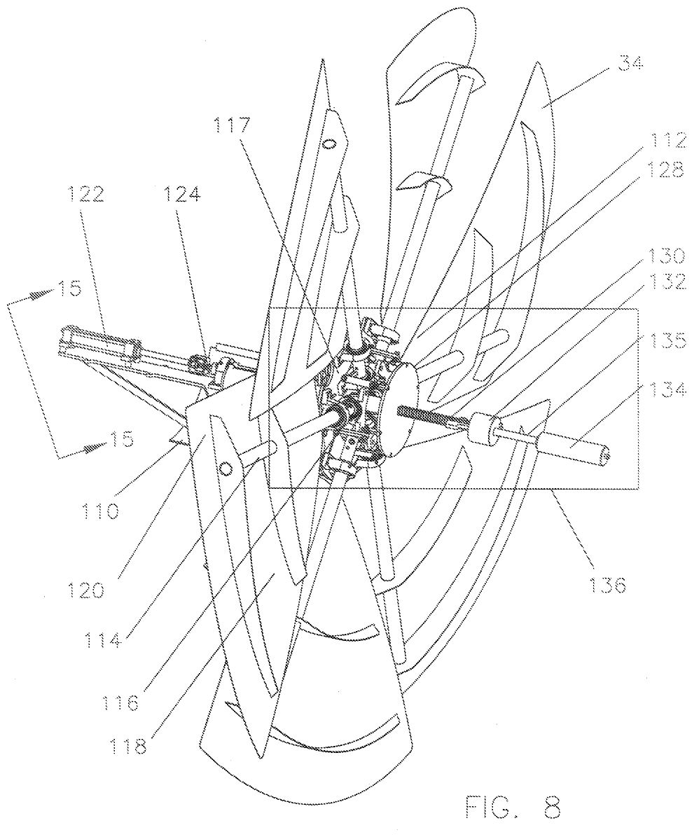

Referring now to FIG. 8, which is a perspective view similar to FIG. 5 showing the wind turbine pod 32 and the blades 34 installed from a convenient ground level position.

Referring now to FIG. 7, winch 82 has been operated to bring the mast 28 to the full vertical position, and a pinned connection has been made at 96 (see FIG. 5). At this time the connection at the pivotable foot 98 can be released. This will allow the lightweight truss 86 to be lowered to the ground with the winch 82 and the cables, wires, ropes, or chains 80 and 88 to be released. The cable, wire, rope, or chain 80 can be rolled up on the winch 82 for storage and the cable, wire, rope, or chains 88 can remain attached to the upper end 89 of the mast 28 for use in future servicing operations. This process can be reversed to bring the wind turbine down to ground level for convenient servicing in the future.

Referring now to FIG. 8, a perspective view of the workings of a wind turbine whose blade angle is sensitive to the wind load are shown which are generally taken along lings “8-8” of FIG. 7. A majority of the cowling is removed with only a portion remaining at 110. The fairing mechanism 112 will be described in detail in the following figures. In the embodiment illustrated in FIG. 8, the blades 34 pivot about a radial axles 114 which rotate about bearings 116 which are mounted on faceplate 117. The blades 34 have a larger surface area 118 on one side of axles 114 than on the other side 120 of axles 114 to give a twisting moment on the axles 114 when the wind blows. Cylinder 122 provides for resetting the blades after they have been completely faired to the 90° position in a high wind. Bearings 124 allow the parts to the right of the bearings to rotate while the parts to the left in this figure do not rotate. Fairing mechanism 112 is shown with release plate 128 which receives the moment force from the blades through linkages and pushes against spring 130 allowing the angle of the blades 34 to be responsive to the wind load. Centrifugal release 132 will be described later. Resetting sleeve 134 will reset the centrifugal release 130 after a high wind event has ended. Resetting sleeve 134 is connected by an internal rod 135 to the cylinder 122 to do this. Box 136 is the fairing mechanism 112 which will be described in FIGS. 9-11.

Referring now to FIG. 9, a partial section of the view of FIG. 8 is shown taken along Box 138 showing the axle 114 rotating in bearings 118 and having a moment arm 150 on axle 114, with a link 152 mounted on the end of the moment arm 150 on one end and mounted on a swivel post 154 on the other end. The swivel post 154 is mounted on the release plate 128. Release plate 128 is loaded by spring 130 and the blade angle will be a balance between the spring load and the wind load.

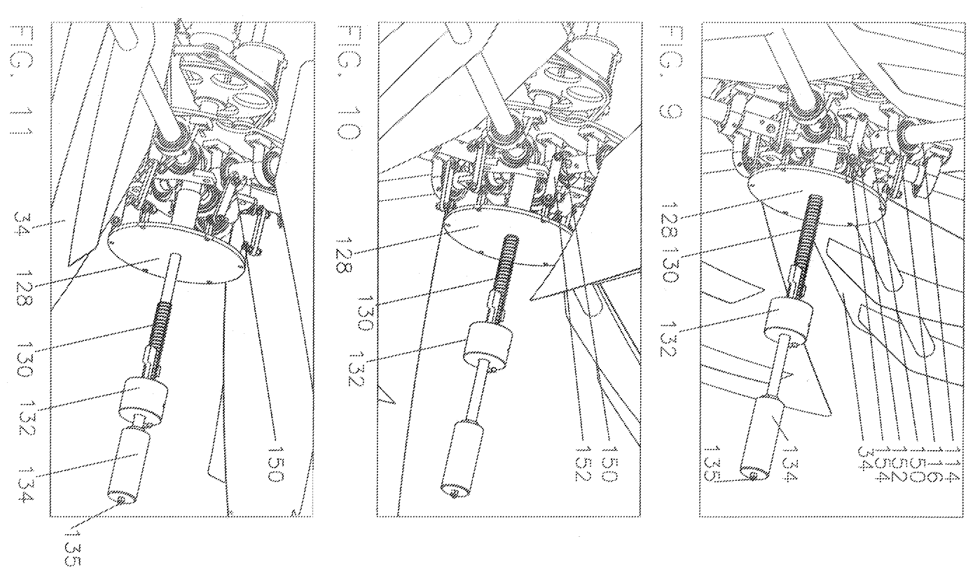

Referring now to FIG. 10 which is a view similar to FIG. 9, the wind load has increased and the moment arm 150 has been rotated, moving link 152, and release plate 128 backwards or to the left in this figure.

Referring now to FIG. 11 which is a view similar to FIG. 9, the wind load has increased to an unsafe level causing the blades to spin at an unsafe speed. The centrifugal release 132 has been released and the blades 34 have moved to the fully faired position. When the wind had died down, the cylinder 122 on the front of the wind turbine will be activated and the resetting sleeve 134 will return the wind turbine to the operational state.

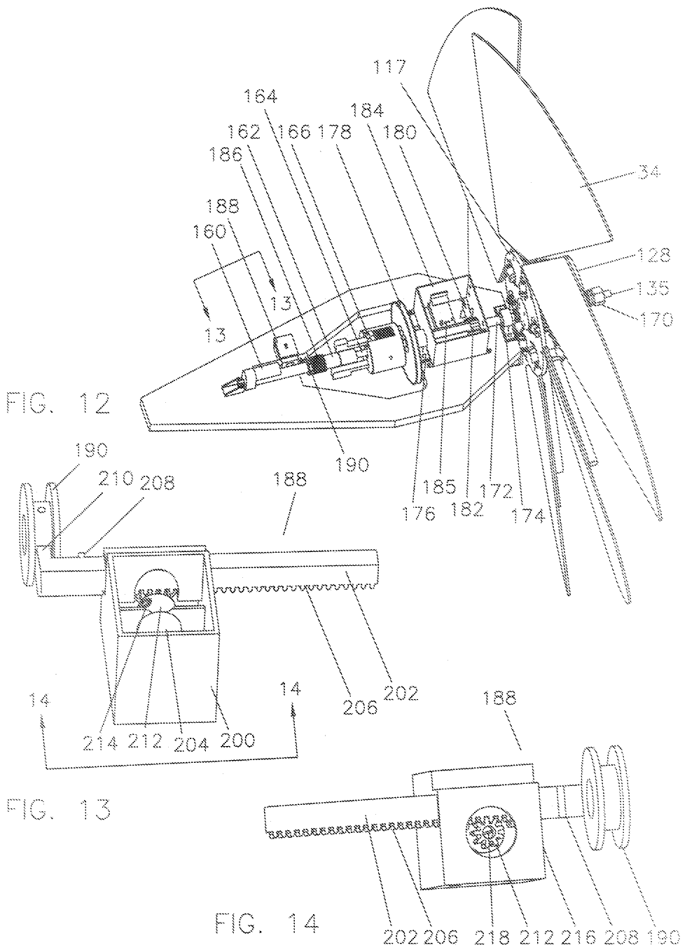

Referring now to FIG. 12 which is a view similar to FIG. 8 rotated slightly and shows a fairing mechanism controlled by a computer system rather than being directly responsive to the wind load. Linear actuator 160 is connected to swivel 162 which is connected to rod 164 which is connected to centrifugal release 166 which is connected to internal rod 135. Release plate 128 is connected to internal rod 135 by fitting 170. As linear actuator 160 extends, centrifugal release 164, internal rod 135 and release plate 128 will move to the right in FIG. 12, causing the blades 34 to be faired to a greater angle. Blades 34 are mounted on faceplate 117 which is mounted on axle 172 which rotates in bearings 174 and 176. Pulley or sprocket 178 is mounted on the end of axle 172 and transmits the generated power to generators or pumps (not seen here). Sensor 180 detects the rotation of sleeve 182 which is mounted on axle 172 to give the rotary speed of the blades 34. The blades 34 rotate in a plane of rotation which is perpendicular to the centerline of axle 172.

Control box 184 contains control components such as the sensor 180, batteries 185, and computer components such as a Raspberry Pi which will communicate via Bluetooth with another computer or a smartphone. Washers 186 can be used to adjust the limits of the stroke of the linear actuator 160. Position sensor 188 will read the position of the linear actuator by engagement with spool 190. The position of the actuator and the load from the generator, alternator or pump as input through the pulley or sprocket 178 will be used to control the rotary speed of the wind turbine.

Referring now to FIG. 13 which is taken along lines “13-13” of FIG. 12, position sensor 188 is shown in a larger scale having a box 200, a slide arm 202, and a rheostat 204. The side arm 202 has a gear rack 208, a stop 208, and an extension 210. The extension 210 fits snuggly within the walls of spool 190 so that the position of the spool 190 and therefore the linear actuator 160 will be accurately measured. The rheostat 204 has a spur gear 212 which has a set screw 214.

Referring now to FIG. 14 which is taken along lines “14-14” of FIG. 13 showing spur gear 212 engaging gear rack 206. As gear rack 208 is moved back and forth by the movement of the spool 190, the spur gear 212 and therefore the rheostat 204 will be rotated, sending a signal to the control box 184. Calibration of the system is done by releasing the set screw 214, moving the slide arm 202 to the left until stop 208 hits the side 216 of the box 200, rotating the rheostat 204 to the stop using the slot 218, and retightening the set screw 214.

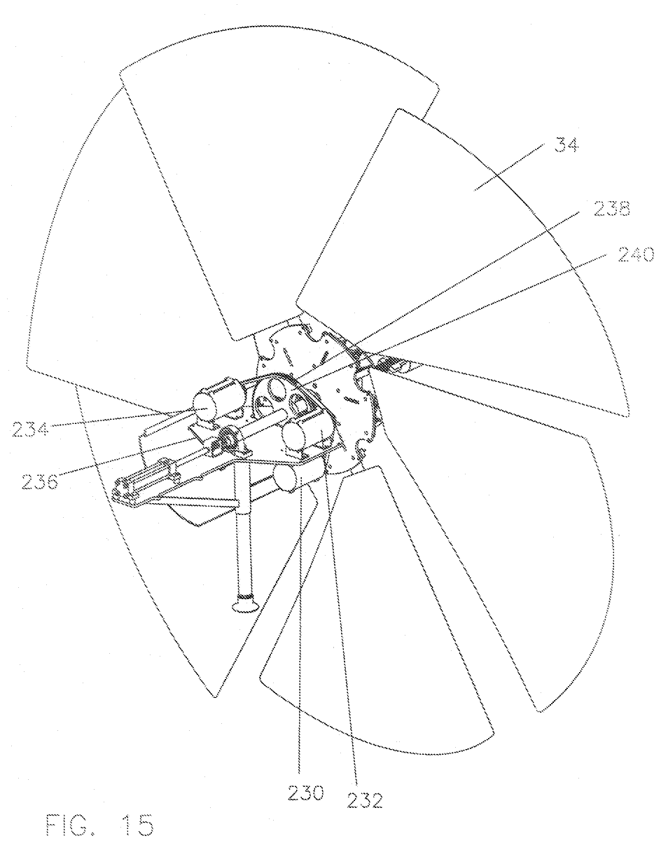

Referring now to FIG. 15, a perspective view of a portion of a wind turbine taken along lines “15-15” of FIG. 8 is shown with generators, alternators, or pumps 230, 232, 234, and 236 (not seen) driven by chain or belt 238 which is in turn driven by sprocket or pulley 240.

Referring now to FIG. 16, which is a perspective view similar to FIG. 15 with the blades 34 faired slightly to illustrate the centrifugal release 132.

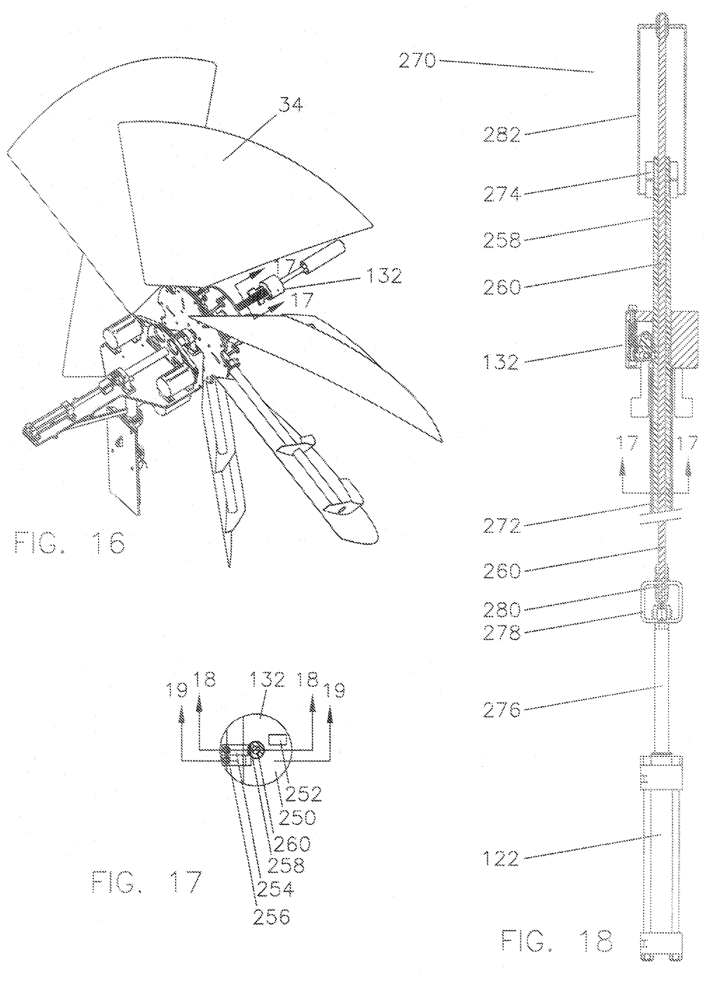

Referring now to FIG. 17, which is a portion of FIG. 16 taken along lines “17-17”. Centrifugal release 132 has a body 250, a counterbalance arm 252, a latch arm 254, a release arm 256 an axle 258 and a reset rod 260.

Referring now to FIG. 18, a view of the centrifugal release system 270 is shown with the centrifugal release 132 mounted on axle 258 and having spring 272 providing a spring load. When the centrifugal release 132 releases, it will move up in FIG. 18 towards stop nuts 274. When the wind has died down, resetting cylinder 122 will extend its rod 276 which pushes bracket 278. Bracket 278 can be made of a short piece of square tubing with holes drilled in the side. Bearings 280 connect bracket 278 to reset rod 260 which connects to resetting sleeve 282. When cylinder 122 is retracted, it will use resetting sleeve 282 to move centrifugal release 132 back to its original position and then return resetting sleeve 282 to the position shown in this figure.

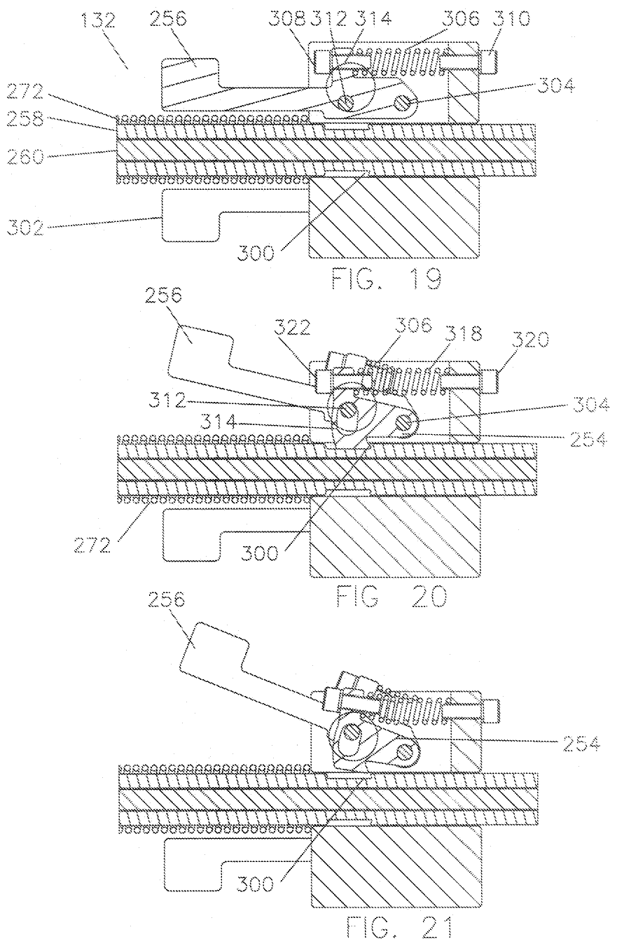

Referring now to FIG. 19 which is a partial section taken along lines “18-18” on FIG. 17 centrifugal release 132 is shown in the unreleased or set condition. Shoulder 300 on axle 258 is shown for engagement by latch arm 254, but the engagement is not actually seen in this view. Counterweight arm 302 is provided for keeping the centrifugal release 132 approximately balance during normal operations. Release arm 256 is pivotably mounted about axle 304 and is restrained in position by spring 306 which is captured between bolts 308 and 310. When release arm 258 is fully released its rotation will be stopped by engagement of pin 312 with hole 314.

Referring now to FIG. 20 which is a view similar to FIG. 19 taken along lines “18-18” of FIG. 17 shows release arm 256 swinging outwardly against the spring load of spring 306 until pin 312 contacts the side of slot 314 as shown. Pin 312 is part of release arm 256 and slot 314 is a part of latch arm 254. Latch arm 254 is pivotably mounted on axle 304 and is restrained in position by the spring load of spring 316 which is retained in position by bolts 320 and 322 as well as the sliding friction load on shoulder 300. This is important as the frictional load on shoulder 300 will vary with wind load as the wind load changes the load on spring 272. This change in load or spring 272 would make the rotary speed which the centrifugal release 132 would release unpredictable. By having the release arm which is only loaded by a simple spring swing to approximately twice the original radius at the before engaging the latch arm 254, the latch arm 264 will immediately be snatched out of the engaged position, giving a predictable release speed.

Referring now to FIG. 21 which is a view similar to FIG. 19 showing the release arm 256 has pivoted further out about axle 304 with pin 312 pulling latch arm 254 out of the groove 330 allowing the centrifugal release 132 to move to the right in this figure, allowing the blades 34 to rotate to the fully faired position. This is the unset position. This will allow the blades 34 and centrifugal release 132 to stop rotating and allow springs 308 and 318 to return release arm 256 and latch arm to assume the original position when moved back to groove 330.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### SEQUENCE LISTING

N/A

That which is claimed is:

1. The method of fairing the blades of a wind turbine having an axis of rotation in which the angle of the blades is sensitive to the wind speed, comprising
providing one or more blades which are pivotably mounted on a blade mounting about a blade axis generally perpendicular to the axis of wind turbine rotation,
providing the blades have more wind surface area facing the wind on one side of the blade axis than the other side of the blade axis giving a torsion on the blades about the blade axis due to wind load,
providing a moment arm mounted on each of the blades which translates the torsion into force proximately parallel to the axis of wind turbine rotation,
providing a reaction plate to receive the force generated by the torsion,
supporting the reaction plate by one or more springs such that increasing wind load will move the reaction plate and change the angle of the blades.

2. The method of claim 1, further comprising providing one or more linkages connect the one or more moment arm to the reaction plate.

3. The method of claim 2, further comprising the connection between the linkage and the moment arm is a swivel connection.

4. The method of claim 2, further comprising the connection between the linkage and the reaction plate is a swivel connection.

5. The method of claim 1, further comprising the blade mounting is a flat plate.

6. The method of claim 1, further comprising in the no wind condition, the angle of the blades to the plane of rotation is approximately ten degrees.

7. The method of claim 1, further comprising with the wind at about twenty miles per hour the angle of the blades to the plane of rotation is approximately thirty degrees.

8. The method of claim 1, further comprising when the blades rotate more than a desired revolutions per minute the blades automatically fair to approximately ninety degrees to the plane of rotation.

9. The method of fairing the blades of a wind turbine having an axis of rotation in which the angle of the blades is sensitive to the wind speed, comprising
providing one or more blades which are pivotably mounted on a blade mounting about a blade axis generally perpendicular to the axis of wind turbine rotation,
providing the blades have more wind surface area facing the wind on one side of the blade axis than the other side of the blade axis giving a torsion on the blades about the blade axis due to wind load,
providing a moment arm mounted on each of the blades which translates the torsion into force proximately parallel to the axis of wind turbine rotation,
providing one or more linkages connect the one or more moment arm to receive the force proximately parallel to the axis of wind turbine rotation
providing a reaction plate to receive the force from the linkages,
supporting the reaction plate by one or more springs such that increasing wind load will move the reaction plate and change the angle of the blades.

10. The method of claim 9, further comprising the connection between the linkage and the moment arm is a swivel connection.

11. The method of claim 9, further comprising the connection between the linkage and the reaction plate is a swivel connection.

12. The method of claim 9, further comprising the blade mounting is a flat plate.

13. The method of claim 9, further comprising in the no wind condition, the angle of the blades to the plane of rotation is approximately ten degrees.

14. The method of claim 9, further comprising with the wind at about twenty miles per hour the angle of the blades to the plane of rotation is approximately thirty degrees.

15. The method of claim 9, further comprising when the blades rotate more than a desired revolutions per minute the blades automatically fair to approximately ninety degrees to the plane of rotation.
